(19) United States
(12) Patent Application Publication
(10) Pub. No.: US 2024/0183970 A1
(43) Pub. Date: Jun. 6, 2024

(54) SCALAR AGILE PARAMETER ESTIMATION (ScAPE)

(71) Applicant: BAE SYSTEMS Information and Electronic Systems Integration Inc., Nashua, NH (US)

(72) Inventor: Matthew Anderson, Mont Vernon, NH (US)

(73) Assignee: BAE SYSTEMS Information and Electronic Systems Integration Inc., Nashua, NH (US)

(21) Appl. No.: 17/971,806

(22) Filed: Oct. 24, 2022

(51) Int. Cl. G01S 13/72

(52) U.S. Cl. CPC G01S 13/726

(57) ABSTRACT

A method, system, and computer readable medium for performing a scalar agile parameter estimation for continuous-valued univariate parameters to estimate and track a likelihood of a measurement where a parameter distribution domain of an emitter is unknown, comprising: receiving a signal from an emitter source; measuring a feature of said signal; calculating a likelihood of said feature by a feature likelihood tracking model; adding a new parameter source model by creating a node, based on said feature likelihood; establishing a likelihood of a measurement using a measurement likelihood tracking model; starting a new feature track, based on said measurement likelihood; and assigning said feature to a track.

### FIELD

The following disclosure relates generally to cognitive learning using various sensor types and, more particularly, to likelihood tracking for online parameter distribution learning and scoring.

### BACKGROUND

In modern electronic warfare (EW) situations, there is a decreasing amount of reliable a priori information about emitter characteristics due to the increasing complexity and agility of modern emitters. For example, an aircraft flying over unknown territory may encounter the problem of multiple unknown signals from one or many unknown emitters. It can be critical to quickly determine “what is out there”. Is there a single, ground-based, radar? Is a hostile aircraft radar painting its target for a missile launch? Are multiple missiles imminently approaching? A system that receives these unknown signals, processes, and displays them as discrete transmitting sources can make the difference between life and death in combat.

In an exemplary environment there are one or more unknown emitters to track. This/these unknown emitter/emitters (measurement source/sources) is/are potentially using different values for a measured parameter, this is referred to as the likelihood tracking problem. This makes it difficult to associate a set of previous measurements (assumed to be) from a single source such as a radar. When a sample observation is made, it would be important to measure how likely a measured parameter is to belong to a set of previous measurements (assumed to be) from a single source.

Determining if measurements are from a single source can involve the problem of combining scores from one parameter with other parameter types, requiring a common reference frame. Further, the parameter distribution domain of the emitter such as a radar is unknown. The problem of adding new sources (such as missiles versus one radar), can become more difficult with the number of observations, not allowing newer sources to have chance to “score”. Regarding overfitting, assigning a node to every measurement would be costly to maintain and compute, consuming valuable time, especially precious in a combat environment. If any measurement parameter value can be emitted by more than one source, parameter tracking cannot uniquely determine which source generated a measurement with any certainty. To combine scores from one parameter with other parameter types, a common reference frame is needed. Additionally, the parameter distribution domain of the emitter is unknown. While a node could be assigned to every measurement, accurately representing the measured data, this would be costly to maintain and compute and has a tendency to overfit.

What is needed is a system and method to provide a likelihood estimate for tracking signals that permits new, previously unseen sources, minimizes overfitting by accounting for measurement uncertainties, and is computationally efficient at scoring.

### SUMMARY

An embodiment provides a Radio Frequency (RF) tracking/localizing system for scalar agile parameter estimation for continuous-valued univariate parameters to estimate and track a likelihood of a measurement from at least one RF emitter source where a parameter distribution domain of the at least one RF emitter is unknown, comprising a memory; and a processor configured to receive a signal from an emitter source; measure a feature of the signal; calculate a likelihood of the feature by an initial feature likelihood tracking model; add a new parameter source model by creating a node, based on the feature likelihood; establish a likelihood of a measurement using a measurement likelihood tracking model; start a new feature track, based on the measurement likelihood; assign the feature to a track, wherein a feature track is a collection of nodes; whereby the signal is determined to be from an identified emitter source by association of each feature with at most one the RF emitter source already being tracked. In embodiments, the feature of the signal comprises a measured parameter ƒ, where the feature comprises one or more directly measured parameters; and a standard deviation σ_{ƒ} of the measured parameter ƒ. In other embodiments, the initial feature likelihood tracking model is for node 1 and comprises the relationship:

p(ƒ)=α(1)w₁ [symbol] (ƒ;ƒ̅₁,σ₁)+(1−α(1)) [symbol] (ƒ;(1−A)ƒ; [symbol] , \vec{f},(1+A)ƒ)

where α(1)=initial fraction of the initial feature likelihood tracking model that is driven by data; w₁=1; [symbol] (x,μ,σ) is a normal probability density function (pdf) with mean μ and standard deviation (std) σ; ƒ=a measured parameter; (x;a,b,c,d) is a trapezoid pdf with parameters a,b,c,d; A=assumed agility factor (0<A<1); ƒ̅₁=ƒ; σ₁=σ_{ƒ}; [symbol] ₁=ƒ; \vec{ƒ}₁=ƒ; W=1; [symbol] =ƒ−3σ_{ƒ}; \vec{ƒ}=ƒ+3σ_{ƒ}; ƒ̅=ƒ; ƒₐ=(1−A)··ƒ; and ƒ_{d}=(1+A)·ƒ. In subsequent embodiments the measurement likelihood tracking model comprises:

$$p ( f ) = α ( W + 1 ) {\sum }_{n = 1}^{N} {w}_{n} 𝒩 ( f ; {\overline{f}}_{n} , {σ}_{n} ) + ( 1 - α ( W + 1 ) ) 𝒯 ( f ; {f}_{a} ; \overleftarrow{f} , \vec{f} , {f}_{d} ) ;$$

$$where α ( x ) = {α}_{0} + ( {α}_{1} - {α}_{0} ) \cdot ς ( x ; {m}_{a} , \frac{1}{2} {m}_{α} ) ;$$

α₀ and α₁ are initial and final fraction where (0<α₀≤α₁<1); mₐ=4 times a slope of sigmoid Membership Function (MF) at m_{60 /}2; m_{α}=a number of measurements to get from α₀ to α₁; W=Σₙ₌₁^{N}wₙ=a total number of measurements; wₙ=a number of measurements represented by node n; [symbol] (x,μ,σ) is a normal probability density function (pdf) with mean μ and standard deviation (std) σ; ƒ=a measured parameter; ƒ̅ₙ=a mean of all measurements represented by node n; σₙ=a standard deviation of all the measurements in node n; (x;a,b,c,d) is a trapezoid pdf with parameters a,b,c,d; ƒₐ=min((1−A)·ƒ̅, [symbol] )=a lowest acceptable measurement; [symbol] =min [symbol] ₙ−3σₙ_{ₘᵢₙ}=a minimum of all measurements minus 3 std; \vec{ƒ}=max \vec{ƒ}ₙ+3σₙ_{ₘₐₓ}=a maximum of all measurements plus 3 std; ƒ_{d}=max((1+A)·ƒ̅, \vec{ƒ})=a highest acceptable measurement; A=an assumed agility factor (0<A<1); and

$$\overline{f} = \frac{1}{N} {\sum }_{n = 1}^{N} {f}_{n} = a$$

mean of nodes. For additional embodiments the processor is configured for setting the agility factor, A, 0<A<1, whereby an unknown parameter distribution domain of the emitter is addressed so that a number of nodes increases over time, and then decreases as a distribution is better learned. In another embodiment, the system generates from the at least one RF emitter source: a parameter from single fixed value; multiple discrete channel values; random selection over a set; and skewed distributions. For a following embodiment, overfitting is reduced by checking, when a node is updated, if a measurement is an extrema, wherein the extrema is either a minimum or a maximum, according to [symbol] ƒₙ=ƒ or \vec{ƒ}ₙ=ƒ; and if ƒ−Nσ_{ƒ}<\vec{ƒ}ₙ₋₁; or if ƒ+Nσ_{ƒ}>\vec{ƒ}ₙ₊₁; then merging corresponding nodes. In subsequent embodiments, when N is less than 3, nodes are merged. In additional embodiments the at least one RF emitter source is characterized as one or more of: a channelized source, wherein only one node is required for each channel; and an agile source, wherein a number of nodes increases over time, and then decreases as a distribution is better learned. In ensuing embodiments the processor is configured to: generate a score for a feature ƒ against existing tracks by computing feature likelihoods; start a new feature track; and update a feature source. In included embodiments the processor is configured to determine if a node exists such that ƒ> [symbol] ₙ and ƒ<\vec{ƒ}ₙ1; then update the node with ƒ; else find a node with minimal innovation; if a normalized innovation is less than a threshold; then update the existing node; else create a new node. In yet further embodiments the minimal innovation is defined by: n*=argmin f̅ₙ−f. In related embodiments the normalized innovation is defined by:

d_{n*}=|ƒ̅_{n*}−ƒ|/\sqrt{σ_{ƒ}²+σ_{n*ƒ}²}.

For further embodiments the system generates: a parameter from a single fixed value; multiple discrete channel values; random selection over a set; and skewed distributions.

Another embodiment provides a computer readable medium having instructions to perform the steps of scalar agile parameter estimation for continuous-valued univariate parameters to estimate and track a likelihood of a measurement where a parameter distribution domain of an emitter is unknown comprising receiving a signal from an emitter source; measuring a feature of the signal; calculating a likelihood of the feature by an initial feature likelihood tracking model; adding a new parameter source model by creating a node, based on the feature likelihood; establishing a likelihood of a measurement using a measurement likelihood tracking model; starting a new feature track, based on the measurement likelihood; and assigning the feature to a track; whereby the signal is determined to be from an identified emitter by association of each of the emitters with a track. For yet further embodiments, the method comprises Gaussian summation of dynamic nodes determined by:

$$p ( f ) = α ( W + 1 ) {\sum }_{n = 1}^{N} {w}_{n} 𝒩 ( f ; {\overline{f}}_{n} , {σ}_{n} ) + ( 1 - α ( W + 1 ) ) 𝒯 ( f ; {f}_{a} ; \overleftarrow{f} , \vec{f} , {f}_{d} )$$

$$where α ( x ) = {α}_{0} + ( {α}_{1} - {α}_{0} ) \cdot ς ( x ; {m}_{a} , \frac{1}{2} {m}_{α} ) ;$$

α₀ and α₁ are initial and final fraction where (0<α₀≤α₁<1); mₐ=4 times a slope of sigmoid Membership Function (MF) at m_{α}/2; m_{α}=a number of measurements to get from α₀ to α₁; W=Σₙ₌₁^{N}wₙ=total number of measurements; wₙ=a number of measurements represented by node n; [symbol] (x,μ,σ) is a normal probability density function (pdf) with mean μ and standard deviation (std) σ; ƒ=a measured parameter; ƒ̅ₙ=a mean of all measurements represented by node n; σₙ=a standard deviation of all the measurements in node n; (x;a,b,c,d) is a trapezoid pdf with parameters a,b,c,d; [symbol] =min [symbol] ₙ−3σₙ_{ₘᵢₙ}=min. of all the measurements minus 3 std; \vec{ƒ}=max \vec{ƒ}ₙ+3Σₙ_{ₘₐₓ}=max. of all the measurements plus 3 std;

$$\overline{f} = \frac{1}{N} {\sum }_{n = 1}^{N} {f}_{n} = mean of nodes ;$$

ƒₐ=min((1−A)·ƒ̅, [symbol] )=lowest acceptable measurement; ƒ_{d}=max((1+A)·ƒ̅, \vec{ƒ})=highest acceptable measurement; and A=an assumed agility factor (0<A<1). For more embodiments, the feature source comprises node creating and updating comprising determining if any node exists such that ƒ> [symbol] ₙ and ƒ<\vec{ƒ}ₙ; then updating that node with ƒ; else finding a node with minimal innovation, such that n*=argmin ƒ̅ₙ−ƒ; if a normalized innovation d_{n*}=|ƒ̅_{n*}−ƒ|/\sqrt{σ_{ƒ}²+σ_{n*ƒ}²} is less than a threshold; then updating the existing node; else, creating a new node. For continued embodiments overfitting is prevented by node merging comprising ordering nodes such that ƒ̅ₙ<ƒ̅ₙ₊₁; determining if a maximum of node n is less than a minimum of node n+1, where ƒ̅ₙ≤\vec{ƒ}ₙ< [symbol] ₙ₊₁≤ƒ̅ₙ₊₁; if ƒ−Nσ_{ƒ}<\vec{ƒ}ₙ₋₁; or ƒ+Nσ_{ƒ}>\vec{ƒ}ₙ₊₁; then merging nodes.

A yet further embodiment provides a method of signals tracking performing a scalar agile parameter estimation for continuous-valued univariate parameters to estimate and track a likelihood of a measurement where a parameter distribution domain of an emitter is unknown, comprising receiving a signal from an emitter source; measuring a feature of the signal; calculating a likelihood of the feature by a feature likelihood tracking model; adding a new parameter source model by creating a node, based on the feature likelihood; establishing a likelihood of a measurement using a measurement likelihood tracking model; starting a new feature track, based on the measurement likelihood; and assigning the feature to a track; whereby the signal is determined to be from an identified emitter by association of each of the emitters with a track. For additional embodiments, the signal is an RF signal.

Implementations of the techniques discussed above may include a method or process, a system or apparatus, or computer software stored on a computer-accessible medium. The details or one or more implementations are set forth in the accompanying drawings and the description below. Other features will be apparent from the description and drawings, and form the claims.

### BRIEF DESCRIPTION OF THE DRAWINGS

FIG. 1 depicts an exemplary environment of unknown emitters to track configured in accordance with an embodiment.

FIG. 2 depicts system components configured in accordance with an embodiment.

FIG. 3 depicts a parameter tracking implementation where one source exists in the database, configured in accordance with an embodiment.

FIG. 4 depicts a parameter tracking implementation where a source that exists in the database has been updated by a new measurement in the database, configured in accordance with an embodiment.

FIG. 5 depicts a first parameter tracking example configured in accordance with an embodiment.

FIG. 6 depicts a second parameter tracking example configured in accordance with an embodiment.

FIG. 7 depicts a third parameter tracking example configured in accordance with an embodiment.

FIG. 8 depicts a fourth parameter tracking example configured in accordance with an embodiment.

FIG. 9 depicts a fifth parameter tracking example configured in accordance with an embodiment.

FIG. 10 is a flowchart for a method for scalar agile parameter estimation where no source exists in the database configured in accordance with an embodiment.

FIG. 11 is a flowchart for a method for scalar agile parameter estimation where a source exists in the database configured in accordance with an embodiment.

FIG. 12 is a flowchart for a method updating the feature source configured in accordance with an embodiment.

FIG. 13 is a flowchart for a method of merging nodes configured in accordance with an embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

This disclosure relates to a parameter tracker that learns and efficiently represents the observed parameter history using a Gaussian summation of dynamic nodes. Embodiment solutions are general, and can be applied to many types of parameter observations. For example, while RF radar signals from sources such as ground radar and missiles can be tracked; other parameters such as parameters measured from laser or sonar detecting devices can be tracked. In each case measurements from emitter(s) are processed to report the one or more sources (emitters) producing the measured signals.

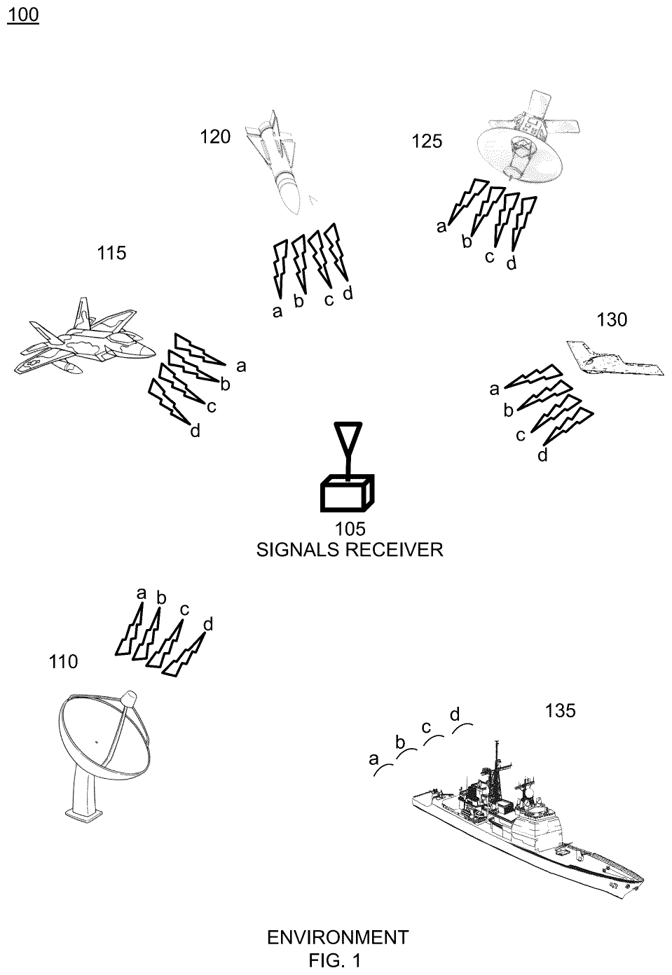

FIG. 1 depicts an exemplary environment 100 of unknown emitters to track. Embodiments operate in this environment, including signals receiver 105. Examples of receivers include an antenna receiving system on a combat aircraft, a laser light receiver on a fixed or mobile platform, and an acoustic receiver array on a ship or submarine. 110-135 represent one or more unknown emitters. Examples include a ground-based radar 110; a manned aircraft 115; a missile 120, a satellite 125, a drone 130; and a ship 135 transmitting signals. While most displayed examples depict RF emissions, those of ordinary skill in the art will recognize that the invention can be applied to any measurable signal. Each of this/these unknown emitter/emitters (measurement source/sources) is/are potentially using different values for a measured parameter (110a-d . . . 135a-d) (the likelihood tracking problem). Parameter examples include frequency and modulation for RF signals, wavelength and pulse length for laser signals, temporal frequency, and spatial frequency for sonar signals. As mentioned, this makes it difficult to associate a set of previous measurements (assumed to be) from a single source. When a sample observation is made, it is important to determine how likely a measured parameter (ex. 110a, 110b, 110c, 110d) is to belong to a set of previous measurements (assumed to be) from a single source (110).

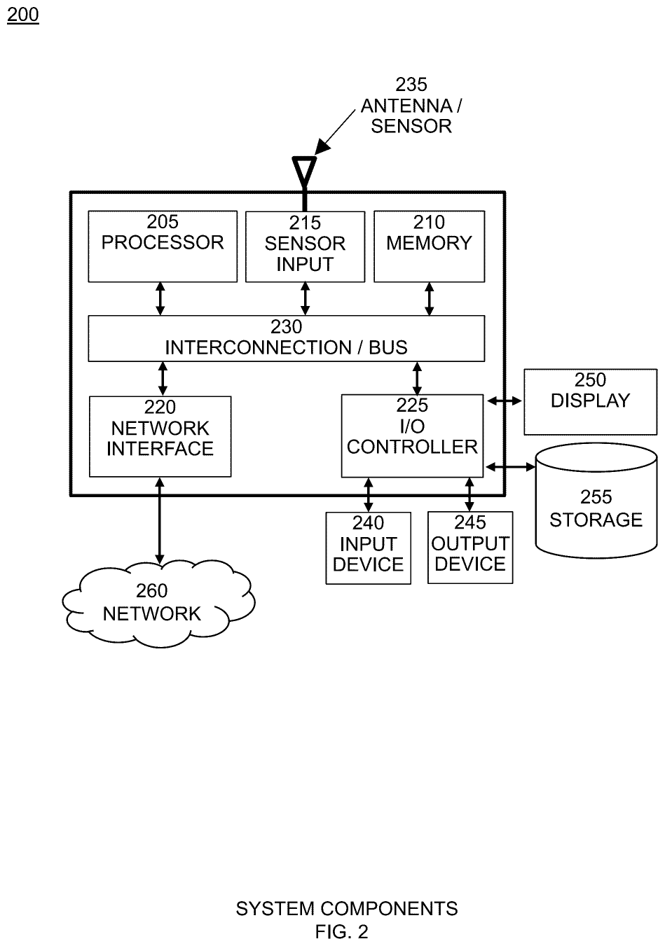

FIG. 2 illustrates an example system 200 according to one or more embodiments. System 200 may be a communication apparatus, such as a computer. System 200 includes, among other components, a processor 205, memory 210 which may be a non-transitory computer readable memory, sensor input 215, network interface 220, and I/O controller 225, each communicatively coupled to an interconnection/bus 230. An antenna/sensor 235 is coupled to sensor input 215. In embodiments, antenna/sensor 235 is an RF antenna/sensor, an optical sensor, or other parameter sensor to make measurements of emitting sources. In embodiments, I/O controller 225 is communicatively coupled to one or more input devices 240, one or more output devices 245, one or more displays 250, and storage 255. Processor 205 is a hardware device for executing hardware instructions or software, particularly those stored in memory 210. The processor 205 may be a custom made or commercially available processor, a central processing unit (CPU), a microprocessor, or other device for executing instructions. Memory 210 may include one or combinations of volatile memory elements and nonvolatile memory elements. Additional data, including, for example, instructions for the processor 205 or other retrievable information, may be stored in storage 255, which may be a storage device such as a hard disk drive or solid state drive. In embodiments, a network interface 220 is connected to network 260.

In likelihood tracking a measurement source (an emitter such as a radar) is potentially using different values for a measured parameter. A sample observation is made and embodiments measure how likely a measured parameter is to belong to a set of previous measurements (assumed to be) from a single source. The value of parameter tracking is that it can be combined with other attributes. This disclosure describes a general approach for continuous-valued univariate parameters.

Implementations of the invention are very flexible with many customizable parameters; therefore, the specific numbers for the parameters are for illustration purposes and parameters can be adjusted depending on the application. Simulation examples show efficacy for sources that generate a parameter from single fixed value, multiple discrete values, random selection over a set, and skewed distributions.

Likelihood tracking involves solving at least four problems: combining scores, unknown emitter parameter distribution, unknown number of new sources, and overfitting. As mentioned previously, the problem of combining scores from one parameter with other parameter types requires a common reference frame. Embodiments use data to estimate/track the likelihood of a measurement. However, the parameter distribution domain of the emitter is unknown. To address this, embodiments assume an agility factor. To address the problem of new sources, embodiments assume that the likelihood of a new (unseen) source from a given source decreases with the number of observations to allow newer sources to have chance to “score”. Regarding overfitting, a node could be assigned to every measurement; however, as previously mentioned, while this may most accurately represent the data, it would be costly to maintain and compute. Instead, embodiments represent the data distribution both as faithfully and efficiently as possible. Embodiment solutions are to utilize estimated measurement error standard deviations to determine when to merge nodes.

To establish the likelihood of a measurement, embodiments use the following likelihood tracking model equation:

p(ƒ)=α(W+1)Σₙ₌₁^{N}wₙ [symbol] (ƒ;ƒ̅ₙ,σₙ)+(1−α(W+1) [symbol] (ƒ;ƒₐ, [symbol] ,\vec{ƒ},ƒ_{d}) Eq. (1)

Here, each node n has a set of parameters, where each node comprises a set of measured parameters that may or may not be attributable to a specific emitter. This equation includes parameter models, maintains up to [symbol] nodes, and uses derived data-driven values where:

1) [symbol] (x;μ,σ) is the normal probability density function (pdf) with mean μ and std σ;
2) [symbol] (x;a,b,c,d) is the trapezoid probability density function (pdf) with parameters a,b,c,d; and
3)

$$α ( x ) = {α}_{0} + ( {α}_{1} - {α}_{0} ) \cdot ς ( x ; {m}_{a} , \frac{1}{2} {m}_{α} )$$

specifies the weighting of the pdf based on nodes as a function of the number of measurements observed.

For parameter models:

1) α₀ and α₁ are initial and final fraction of the model that is driven by data/observations where (0<α₀≤α₁<1)
2) mₐ=four times the slope of sigmoid Membership Function (MF) at m_{α}/2. Membership function is a term of art, and represents the degree of truth in fuzzy logic.
3) m_{α}=number of measurements to get from α₀ to α₁ and
4) A=assumed agility factor (0<A<1), as in ƒₐ=min((1−A)·ƒ̅, [symbol] ) defined below.

Each of up to N nodes maintains the following:

1) wₙ=number of measurements represented by node n
2) ƒ̅ₙ=mean of all the measurements represented by node n
3) σₙ=standard deviation of all the measurements in node n
4) [symbol] ₙ=minimum of all the measurements represented by the node n and
5) \vec{ƒ}ₙ=maximum of all the measurements represented by the node.

Derived (data driven) values include:

1) W=Σₙ₌₁^{N}wₙ=total number of measurements across all measured parameters, even if the parameters are of different types.
2) [symbol] =min [symbol] ₙ−3σₙ_{ₘᵢₙ}=minimum of all the measurements minus 3 standard deviations (std)
3) \vec{ƒ}=max \vec{ƒ}ₙ+3σₙ_{ₘₐₓ}=maximum of all the measurements plus 3 std
4)

$$\overline{f} = \frac{1}{N} {\sum }_{n = 1}^{N} {f}_{n} = mean of nodes$$

5) ƒₐ=min((1−A)·ƒ̅, [symbol] )=lowest acceptable measurement and
6) ƒ_{d}=max((1+A)·ƒ̅, \vec{ƒ})=highest acceptable measurement, where A is a predetermined parameter.

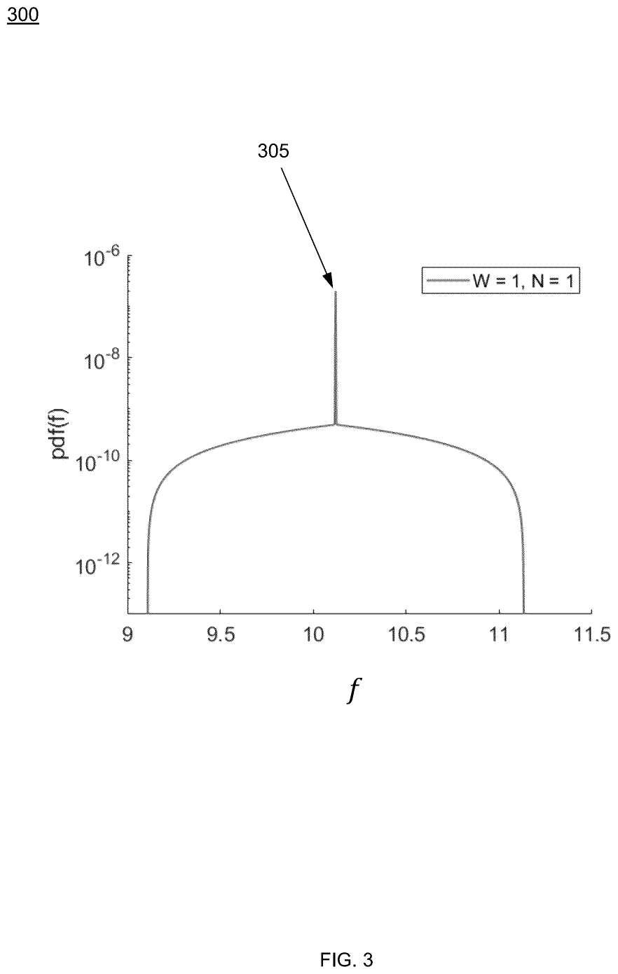

FIG. 3 depicts a parameter tracking implementation 300 where no source exists in the database. For the initial conditions:
1) no source exists in database, and
2) a feature is measured: ƒ, σ_{ƒ}
   where ƒ=a measured parameter, and σ_{ƒ}=the std of measured parameter ƒ.

The likelihood of feature ƒ is modeled as:

p(ƒ)=α(1)w₁ [symbol] (ƒ;ƒ̅₁,σ₁)+(1−α(1)) [symbol] (ƒ;(1−A)ƒ; [symbol] , \vec{ƒ},(1+A)ƒ) Eq. (2)

The system then performs the steps of adding a new parameter source model. When no sources exist in the database, this entails receiving a series of measurements (of some parameter), determining the standard deviation, and assuming the remaining values. Node #1 is created with:

w₁=1

ƒ̅ₙ=ƒ

σ₁=σ_{ƒ}

[symbol]

₁=ƒ

\vec{ƒ}₁=ƒ

Having derived parameters of:

W=1

[symbol]

=ƒ−3σ_{ƒ}

\vec{ƒ}=ƒ+3σ_{ƒ}

ƒ̅=ƒ

ƒₐ=(1−A)··ƒ

ƒ_{d}=(1+A)·ƒ

As seen in the FIG. 3 graph, the resultant pdf(ƒ) peak 305 has a probability density function pdf(ƒ) value of about 10⁻⁷ for ƒ=about 10.25. Nonzero values of the pdf span values of ƒ from about 9.1 to 11.1 to represent the lower likelihoods of unobserved measurement values. As known to one of skill in the art of probability theory, the probability density function (pdf) provides the relative likelihood that the value of a continuous random variable would be close to a given sample point. Here, 10⁻⁷ is the likelihood that 10.25 is close to a given sample point.

### Updating

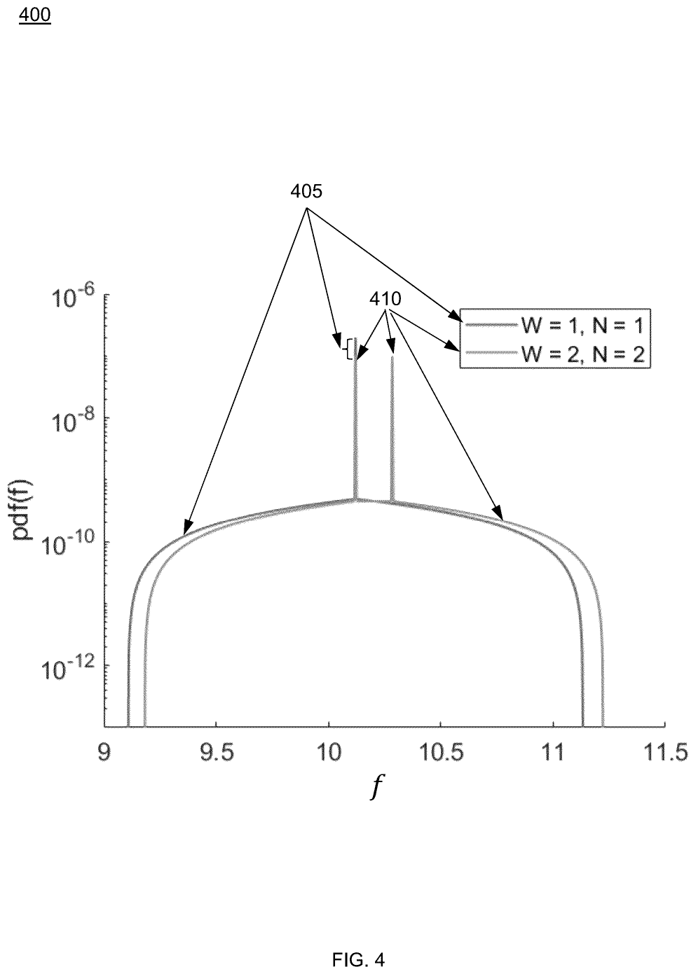

FIG. 4 depicts a parameter tracking implementation 400 where sources exist in the database. Here, the initial conditions specify that sources exist in the database and a feature is measured, defined by ƒ and σ_{ƒ} where ƒ=a measured parameter, and σ_{ƒ}=the standard deviation of measured parameter.

The system performs the steps of:

1) scoring ƒ against existing tracks (i.e., compute likelihoods using previous FIG. 3 scenario);
2) starting a new feature track (following procedures of FIG. 3 scenario); and
3) updating the feature source.
Updating the feature source comprises the following steps:
1) If any node exists such that ƒ> [symbol] ₙ and ƒ<\vec{ƒ}ₙ;
2) Then update that node with ƒ;
3) Else, find a node with minimal innovation n*, such that n*=argmin ƒ̅ₙ−ƒ. As known in the signal processing art, the innovation is the difference between the observed value of a variable at a given time and the best forecast of the value, based on information available before the given time. Minimal innovation n* is the smallest difference between the observed value and the best forecast of the value.
Further, if d_{n*}, the normalized innovation defined as:

dₙ*=|ƒ_{n*}−ƒ|/\sqrt{σ_{ƒ}²+σ_{n*}²} Eq. (3)

is less than a threshold;
Then update the existing node;
Else, create a new node. The normalized innovation d_{n*} is the magnitude of ƒ̅_{n*}−ƒ, similar to the minimal innovation, divided by the square root of the sum of the squares of the standard deviations.

As seen in the graph of FIG. 4, the resultant pdf(ƒ) peak 405, associated with the one measurement, one node (W=1 and N=1) curve from the measured values, is slightly lower (by about 10^{-0.1}) in curve 410 associated with two measurements, two nodes (W=2 and N=2) for ƒ=about 10.15. 10.15 is the value of the first measurement, and 10.35 is the value of the second measurement in this working example. The 410 curve shows a second additional peak for ƒ equal to about 10.35, which reflects an additional measurement added to the distribution estimate. Curve 410 is the update of curve 405, after processing the second measurement of 10.35.

### Merging

A key concept for the merging of nodes is to minimize overfitting and reduce computations needed to represent the data distribution as faithfully and efficiently as possible. This is akin to a model order selection problem. As known to one of skill in the art of statistical modeling, the model selection problem refers to choosing, from a set of candidates, a model that is as simple as possible while still retaining a sufficient predictive power. While a node could be assigned to every measurement, and this may most accurately represent the data, it would be costly to maintain and compute, and generally is called overfitting. However, to avoid overfitting, embodiments employ an efficient merging scheme which will be described in more detail in the following paragraph.

For merging, first the nodes are ordered. For fast computations, the nodes are ordered such that ƒ̅ₙ<ƒ̅ₙ₊₁. Further constraints provide that the maximum of node n is less than the minimum of node n+1, so therefore: ƒ̅ₙ≤\vec{ƒ}ₙ< [symbol] ₙ₊₁≤ƒ̅ₙ₊₁. Merging criteria are mathematically established such that when a node is updated and that measurement is an extrema (i.e., ƒ= [symbol] ₙ or ƒ=\vec{ƒ}ₙ), embodiments check to see if: ƒ−Nσ_{ƒ}<\vec{ƒ}ₙ₋₁ or ƒ+Nσ_{ƒ}>\vec{ƒ}ₙ₊₁ . If either is true, then the corresponding nodes are merged. For embodiments, the value of N should be modest (less than 3). In other words, the criterion for merging is declaring that the nodes should be merged if a measurement with a little measurement noise would have resulted in the measurement updating a different node.

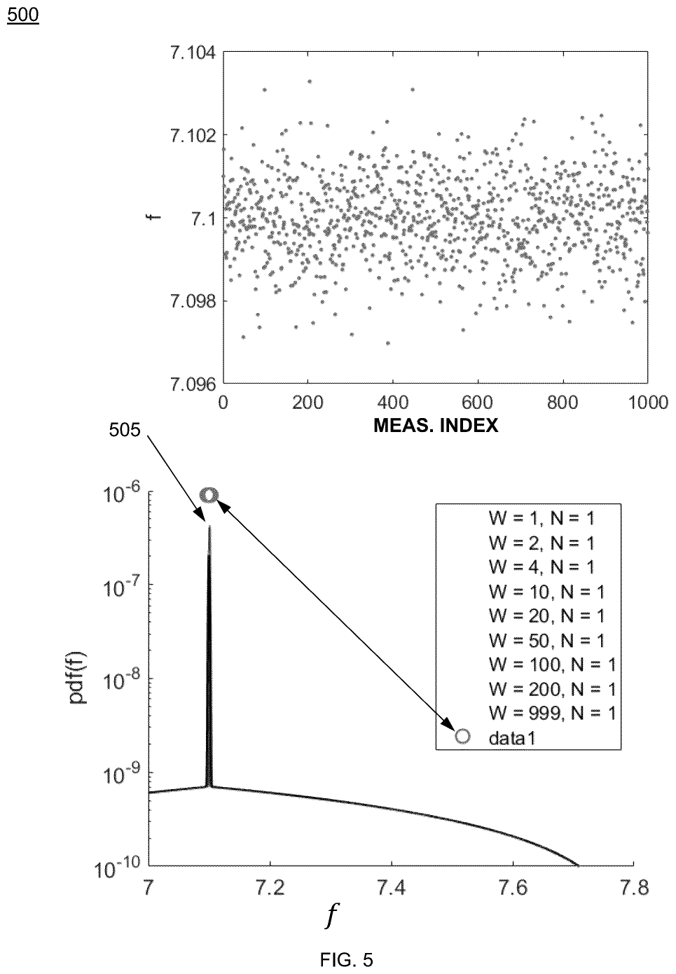

FIG. 5 depicts the first parameter tracking example 500. Here, source ƒ=7.1 with σ_{ƒ=}0.001. This example presents the easiest source, it only requires one node to represent, and is therefore very efficient. After the first measurement (MEAS. INDEX=1), the likelihood is pretty tight, and not necessarily reflective of the true dispersion of measurements. The likelihoods after processing MEAS. INDEX 2, 4, 10, and 20 are similar in form/shape. After processing MEAS. INDEX, the likelihood is pushing down the likelihood that frequencies outside of the 7.1 region for ƒ. After 100 updates, the likelihoods are nearly fixed as seen with single peak 505.

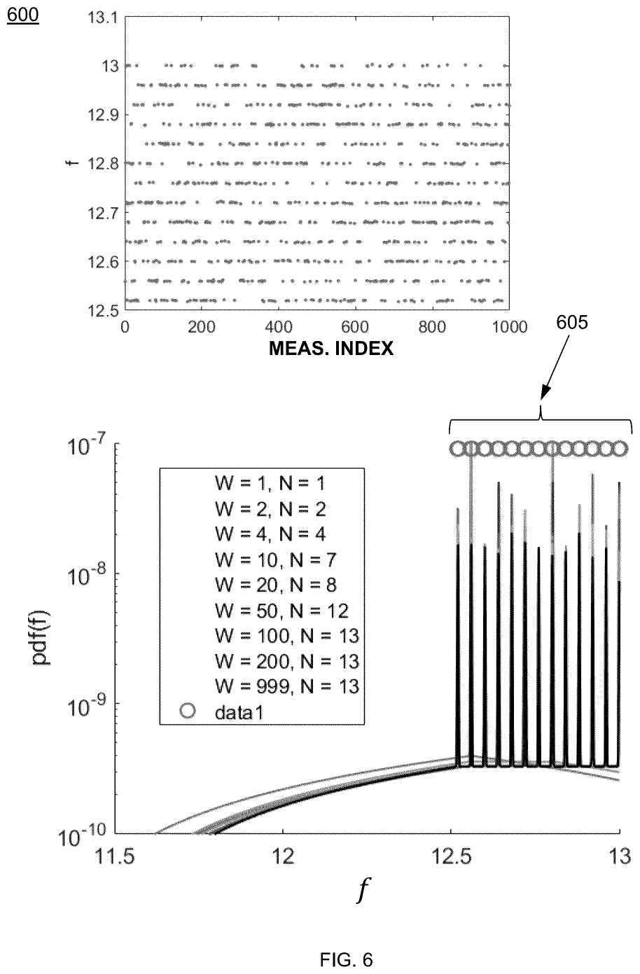

FIG. 6 depicts a second parameter tracking example 600. Here, source ƒ={12.5+[0, 0.04, 0.08, . . . , 1]} with σ_{ƒ}=0.001. This example can be described as a “channelized” source; it requires only one node for each of the 13 channels 605. After the first measurement, the likelihood is pretty tight; however, not reflective of the true dispersion of measurements. The likelihood builds-up to capture the discrete channels as MEAS. INDEX 2, 4, 10, and 20 are processed. After processing MEAS. INDEX 50, the likelihood is pushing down the likelihood that parameters are outside of the 12.5 to 13 region for ƒ. After processing 100 updates, the likelihoods are nearly fixed.

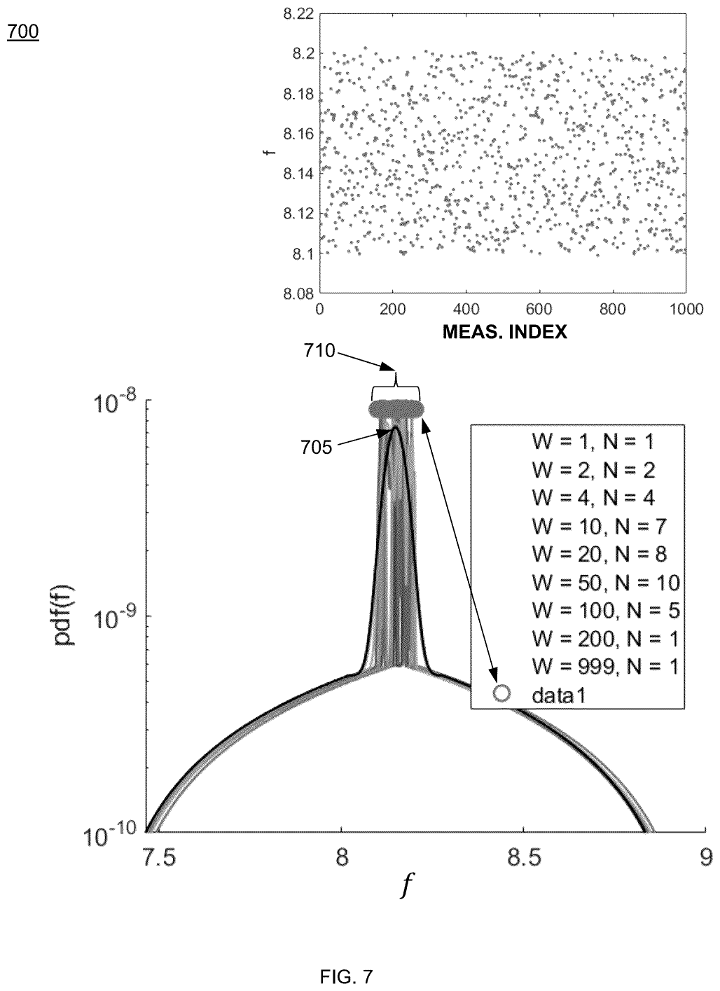

FIG. 7 depicts a third parameter tracking example 700. Here, source ƒ˜Uniform(8.1, 8.2) with σ_{ƒ}=0.001. This example can be described as an “agile” source, the number of nodes increases over time, and then decreases as the distribution is better learned. After the first measurement, the likelihood is pretty tight and not reflective of true dispersion of measurements, and “overfitting” continues while the number of observations is relatively small (<˜100). After processing MEAS. INDEX 200, a single Gaussian node 705 is approximating the actual uniform distribution over the 8.1 to 8.2 region for ƒ 710.

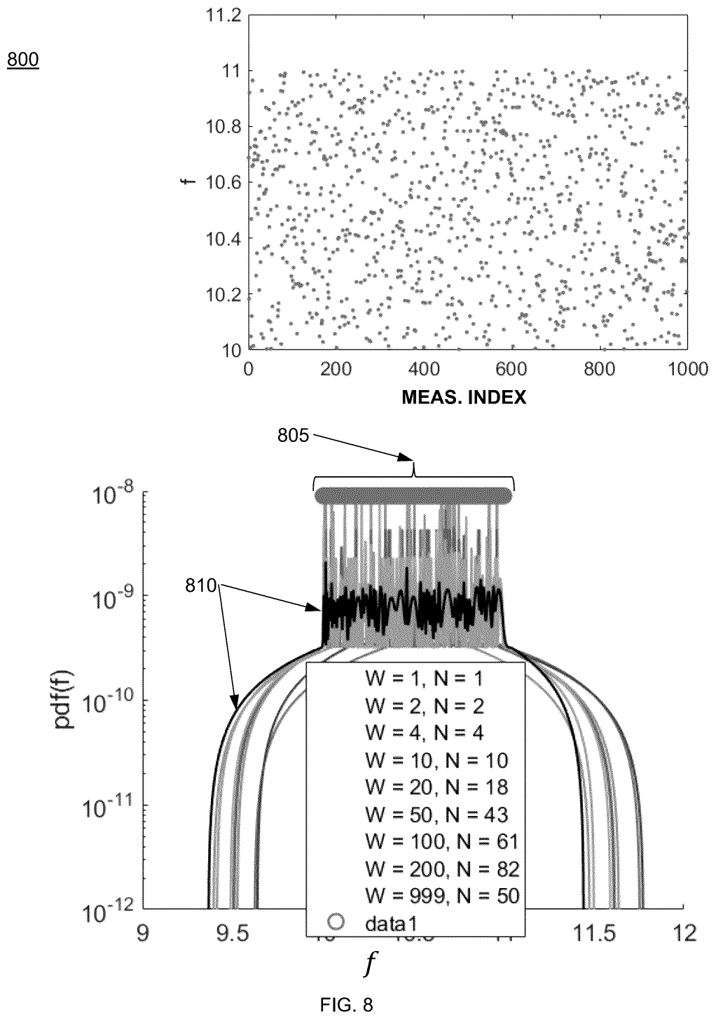

FIG. 8 depicts a fourth parameter tracking example 800. Here, source ƒ˜Uniform(10, 11) with σ_{ƒ}=0.001. This example is also described as an “agile” source, the number of nodes increases over time, and then decreases as the distribution is better learned. After the first measurement, the likelihood is pretty tight, and not reflective of true dispersion of measurements. Again, “overfitting” continues while the number of observations is relatively small (here <˜1000). However, the number of nodes 805 is beginning to decrease 810, after MEAS. INDEX 200, there are 82 nodes which decreases to 50 nodes after MEAS. INDEX 1000 is processed.

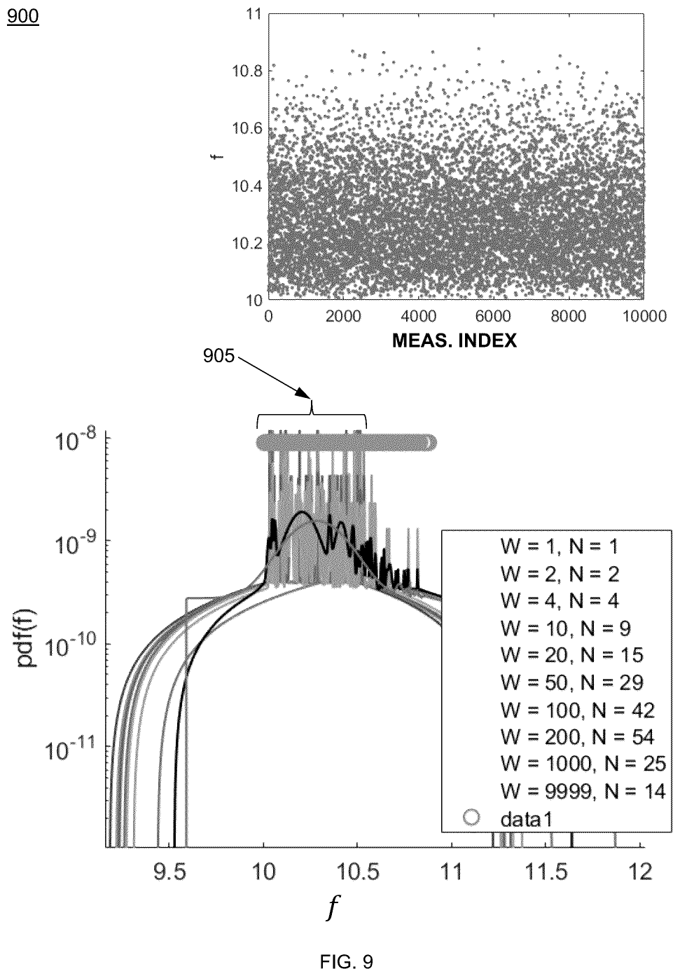

FIG. 9 depicts a fifth parameter tracking example 900. Source ƒ˜0.5 β(2, 5)+9, where β(a,b) is the standard beta distribution with positive shape parameters a and b. The feature has measurement standard deviation σ_{ƒ}=0.001. It is another example of an “agile” source. The number of nodes increases over time, and then decreases as the distribution is better learned. After the first measurement, the likelihood is pretty tight and not reflective of true dispersion of measurements, and “overfitting” continues while the number of observations is relatively small (<˜1000). Here, the number of nodes 905 stays manageable, i.e., N≤54.

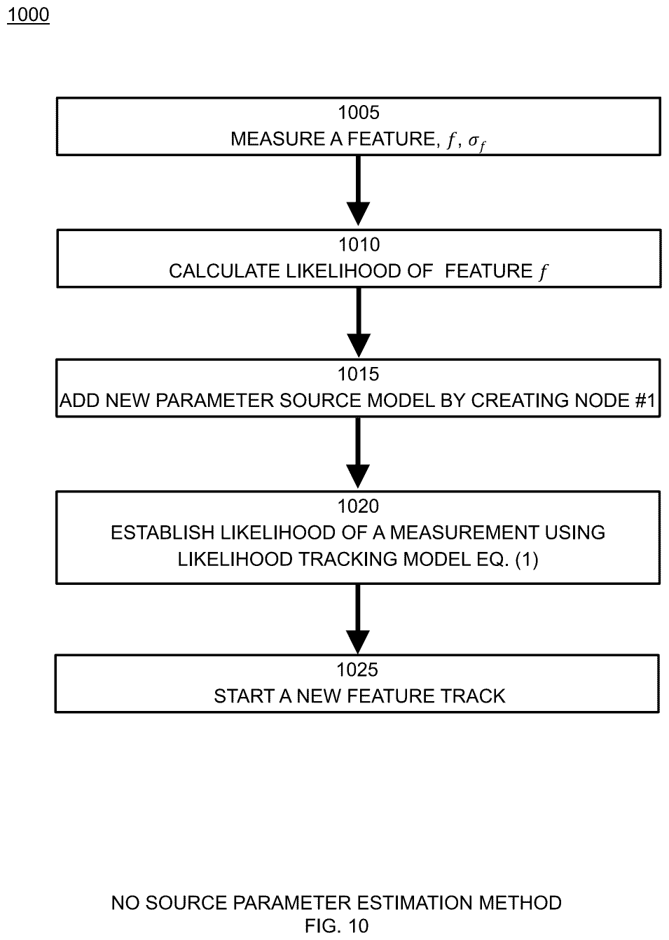

FIG. 10 is a flowchart 1000 for a method for scalar agile parameter estimation for continuous-valued univariate parameters to estimate and track the likelihood of a measurement where the parameter distribution domain of the source is unknown. Where no source exists in the database, 1) measure a feature, ƒ, σ_{ƒ} 1005, (where ƒ=a measured parameter, and σ_{ƒ}=the standard deviation of measured parameter ƒ); 2) calculate the likelihood of feature ƒ according to Eq. (2) 1010; 3) add a new parameter source model by creating a node #1 1015; 4) establish the likelihood of a measurement using likelihood tracking model Eq. (1) 1020; 5) start a new feature track 1025.

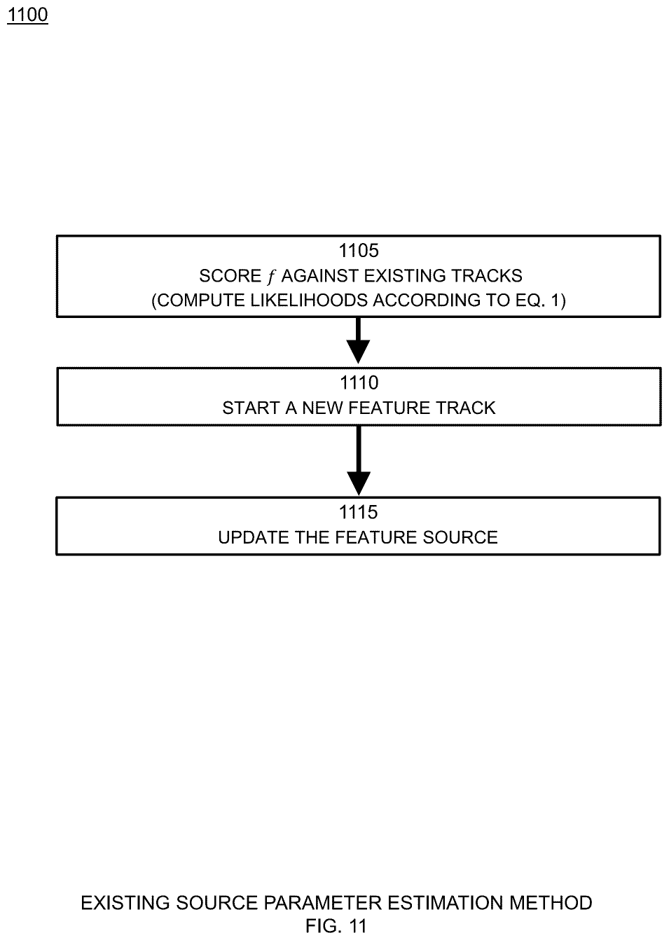

FIG. 11 is a flowchart 1100 for a method for scalar agile parameter estimation for continuous-valued univariate parameters where a source exists in the database. Steps comprise: 1) scoring ƒ against existing tracks (i.e., compute likelihoods according to Eq. 1) 1105; 2) starting a new feature track 1110; 3) updating the feature source 1115.

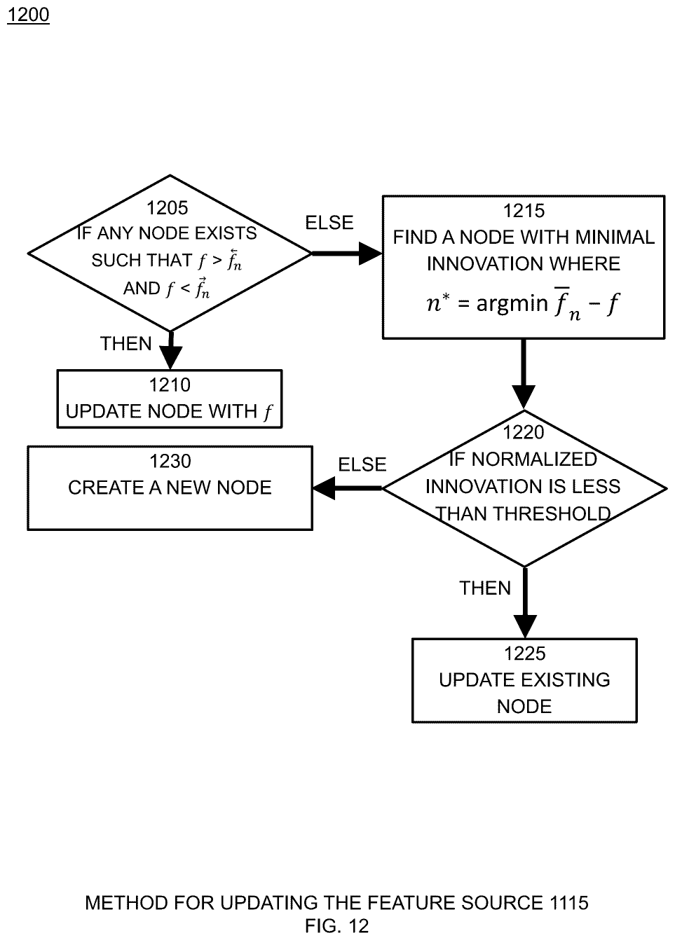

FIG. 12 is a flowchart 1200 for a method updating the feature source. Updating the feature source 1115 comprises the following steps: 1) if any node exists such that ƒ> [symbol] ₙ and ƒ<\vec{ƒ}ₙ 1205; 2) then update that node with ƒ 1210; 3) else find a node with minimal innovation, such that n*=argmin ƒ̅ₙ−ƒ 1215; if the normalized innovation d_{n*}=|ƒ̅ₙ−ƒ|/\sqrt{σ_{ƒ}²+σ_{n*ƒ}²} Eq. (3) is less than the threshold 1220; then update the existing node 1225; else, create a new node 1230.

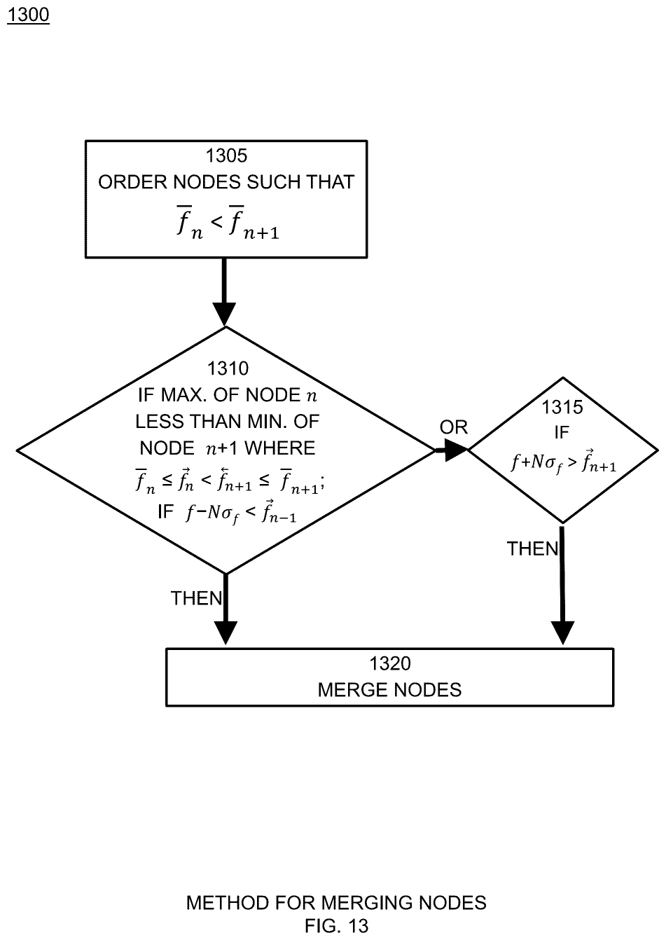

FIG. 13 is a flowchart 1300 for a method of merging nodes. It comprises ordering nodes such that ƒ̅ₙ<ƒ̅ₙ₊₁ 1305, where the maximum of node n is less than the minimum of node n+1, where ƒ̅ₙ≤\vec{ƒ}ₙ< [symbol] ₙ₊₁≤ƒ̅ₙ₊₁; if ƒ−Nσ_{ƒ}<\vec{ƒ}ₙ₋₁ 1310; or ƒ+Nσ_{ƒ}>\vec{ƒ}ₙ₊₁ 1315; then merge nodes 1320, for embodiments, the value of N should be modest (less than 3).

The computing system used for scalar agile parameter estimation for performing (or controlling) the operations or functions described hereinabove with respect to the system and/or the method may include a processor, FPGA, I/O devices, a memory system, and a network adaptor. The computing system includes a program module (not shown) for performing (or controlling) the operations or functions described hereinabove with respect to the system and/or the method according to exemplary embodiments. For example, the program module may include routines, programs, objects, components, logic, data structures, or the like, for performing particular tasks or implement particular abstract data types. The processor may execute instructions written in the program module to perform (or control) the operations or functions described hereinabove with respect to the system and/or the method. The program module may be programmed into the integrated circuits of the processor. In an exemplary embodiment, the program module may be stored in the memory system or in a remote computer system storage media.

The computing system may include a variety of computing system readable media. Such media may be any available media that is accessible by the computer system, and it may include both volatile and non-volatile media, removable and non-removable media.

The memory system can include computer system readable media in the form of volatile memory, such as random access memory (RAM) and/or cache memory or others. The computer system may further include other removable/non-removable, volatile/non-volatile computer system storage media. The computer system can communicate with one or more devices using the network adapter. The network adapter may support wired communications based on Internet, LAN, WAN, or the like, or wireless communications based on CDMA, GSM, wideband CDMA, CDMA-2000, TDMA, LTE, wireless LAN, Bluetooth, or the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to a flowchart illustration and/or block diagram of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of the embodiments has been presented for the purposes of illustration and description. It is not intended to be exhaustive or to limit the invention to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A Radio Frequency (RF) tracking/localizing system for scalar agile parameter estimation for continuous-valued univariate parameters to estimate and track a likelihood of a measurement from at least one RF emitter source where a parameter distribution domain of said at least one RF emitter is unknown, comprising:
a memory; and
a processor configured to:
receive a signal from an emitter source;
measure a feature of said signal;
calculate a likelihood of said feature by an initial feature likelihood tracking model;
add a new parameter source model by creating a node, based on said feature likelihood;
establish a likelihood of a measurement using a measurement likelihood tracking model;
start a new feature track, based on said measurement likelihood;
assign said feature to a track, wherein a feature track is a collection of nodes;
whereby said signal is determined to be from an identified emitter source by association of each feature with at most one said RF emitter source already being tracked.

2. The system of claim 1 wherein said feature of said signal comprises:
a measured parameter ƒ, wherein said feature comprises one or more directly measured parameters; and
a standard deviation σ_{f} of said measured parameter ƒ.

3. The system of claim 1 wherein said initial feature likelihood tracking model is for node 1 and comprises:
p(ƒ)=α(1)w₁ [symbol] (ƒ;ƒ̅₁,σ₁)+(1−α(1)) [symbol] (ƒ;(1−A) [symbol] ; \vec{ƒ},(1−A)ƒ)
where:
a(1)=initial fraction of said initial feature likelihood tracking model that is driven by data;
w₁=1; [symbol]
(x,μ,σ) is a normal probability density function (pdf) with mean μ and standard deviation (std) σ;
ƒ=a measured parameter; [symbol]
(x;a,b,c,d) is a trapezoid pdf with parameters a,b,c,d;
A=assumed agility factor (0<A<1);
ƒ̅₁=ƒ
σ₁=σ_{ƒ}; [symbol]
₁=ƒ;
\vec{ƒ}₁=ƒ;
W=1; [symbol]
=ƒ−3σ_{ƒ};
\vec{ƒ}=ƒ+3σ_{ƒ};
ƒ̅=ƒ;
ƒₐ=(1−A)··ƒ; and
ƒ_{d}=(1+A)·ƒ.

4. The system of claim 1 wherein said measurement likelihood tracking model comprises:
p(ƒ)=α(W+1)Σₙ₌₁^{N}wₙ [symbol] (ƒ;ƒ̅ₙ,σₙ)+(1−α(W+1) [symbol] (ƒ;ƒₐ, [symbol] ,\vec{ƒ},ƒ_{d});
where:
$$α ( x ) = {α}_{0} + ( {α}_{1} - {α}_{0} ) \cdot ς ( x ; {m}_{a} , \frac{1}{2} {m}_{α} ) ;$$
α₀ and α₁ are initial and final fraction where (0<α₀≤α₁<1);
mₐ=4 times a slope of sigmoid Membership Function (MF) at m_{α}/2;
m_{α}=a number of measurements to get from α₀ to α₁;
W=Σₙ₌₁^{N} wₙ=a total number of measurements;
wₙ=a number of measurements represented by node n; [symbol]
(x,μ,σ) is a normal probability density function (pdf) with mean μ and standard deviation (std) σ;
ƒ=a measured parameter;
ƒ̅ₙ=a mean of all measurements represented by node n;
σₙ=a standard deviation of all the measurements in node n; [symbol]
(x;a,b,c,d) is a trapezoid pdf with parameters a,b,c,d;
ƒₐ=min((1−A)·ƒ̅, [symbol] )=a lowest acceptable measurement; [symbol]
=min [symbol] ₙ−3σₙ_{ₘᵢₙ}=a minimum of all measurements minus 3std;
\vec{ƒ}=max \vec{ƒ}ₙ+3σₙ_{ₘₐₓ}=a maximum of all measurements plus 3 std;
ƒ_{d}=max((1+A)·ƒ̅, \vec{ƒ})=a highest acceptable measurement;
A=an assumed agility factor (0<A<1); and
$$\overline{f} = \frac{1}{N} {\sum }_{n = 1}^{N} {f}_{n} = mean of nodes .$$

5. The system of claim 3, wherein said processor is configured for: setting said agility factor, A, 0<A<1, whereby an unknown parameter distribution domain of the emitter is addressed so that a number of nodes increases over time, and then decreases as a distribution is better learned.

6. The system of claim 1, wherein said system generates from said at least one RF emitter source:
a parameter from single fixed value;
multiple discrete channel values;
random selection over a set; and
skewed distributions.

7. The system of claim 1, wherein:
overfitting is reduced by checking, when a node is updated, if a measurement is an extrema, wherein said extrema is either a minimum or a maximum, according to [symbol] ₙ=ƒ or \vec{ƒ}ₙ=ƒ; and
if f−Nσ_{ƒ}<\vec{ƒ}ₙ₋₁; or
if ƒ+Nσ_{ƒ}>\vec{ƒ}ₙ₊₁; then
merging corresponding nodes.

8. The system of claim 7, wherein N is less than 3, whereby nodes are merged.

9. The system of claim 8 wherein said at least one RF emitter source is characterized as one or more of:
a channelized source, wherein only one node is required for each channel; and
an agile source, wherein a number of nodes increases over time, and then decreases as a distribution is better learned.

10. The system of claim 1, wherein said processor is configured to:
generate a score for a feature ƒ against existing tracks by computing feature likelihoods;
start a new feature track; and
update a feature source.

11. The system of claim 1 comprising feature source updating wherein said processor is configured to:
determine if a node exists such that ƒ> [symbol] ₙ and ƒ<\vec{ƒ}ₙ 1; then
update said node with ƒ; else
find a node with minimal innovation;
if a normalized innovation is less than a threshold; then
update said existing node; else
create a new node.

12. The system of claim 11 wherein said minimal innovation is defined by:
n*=argmin ƒ̅ₙ−ƒ.

13. The system of claim 11 wherein said normalized innovation is defined by:
d_{n*}=|ƒ̅_{n*}−ƒ|/\sqrt{σ_{ƒ}²+σ_{n*ƒ}²}.

14. The system of claim 1 wherein said system generates:
a parameter from a single fixed value;
multiple discrete channel values;
random selection over a set; and
skewed distributions.

15. A computer readable medium having instructions to perform the steps of scalar agile parameter estimation for continuous-valued univariate parameters to estimate and track a likelihood of a measurement where a parameter distribution domain of an emitter is unknown comprising:
receiving a signal from an emitter source;
measuring a feature of said signal;
calculating a likelihood of said feature by an initial feature likelihood tracking model;
adding a new parameter source model by creating a node, based on said feature likelihood;
establishing a likelihood of a measurement using a measurement likelihood tracking model;
starting a new feature track, based on said measurement likelihood; and
assigning said feature to a track;
whereby said signal is determined to be from an identified emitter by association of each of said emitters with a track.

16. The computer readable medium of claim 15 wherein said method comprises Gaussian summation of dynamic nodes determined by:
p(ƒ)=Ε(W+1)Σₙ₌₁^{N}wₙ [symbol] (ƒ;ƒ̅ₙ,σₙ)+(1−α(W+1)) [symbol] (ƒ;ƒₐ, [symbol] ,\vec{ƒ},ƒ_{d})
where:
$$α ( x ) = {α}_{0} + ( {α}_{1} - {α}_{0} ) \cdot ς ( x ; {m}_{a} , \frac{1}{2} {m}_{α} ) ;$$
α₀ and α₁ are initial and final fraction where (0<α₀≤α₁<1);
mₐ=4 times a slope of sigmoid Membership Function (MF) at m_{α}/2;
m_{α}=a number of measurements to get from α₀ to α₁;
W=Σₙ₌₁^{N}wₙ=total number of measurements;
wₙ=a number of measurements represented by node n; [symbol]
(x,μ,σ) is a normal probability density function (pdf) with mean μ and standard deviation (std) σ;
ƒ=a measured parameter;
ƒ̅ₙ=a mean of all measurements represented by node n;
σₙ=a standard deviation of all the measurements in node n; [symbol]
(x;a,b,c,d) is a trapezoid pdf with parameters a,b,c,d; [symbol]
=min [symbol] ₙ−3σₙ_{ₘᵢₙ}=min. of all the measurements minus 3 std;
\vec{ƒ}=max \vec{ƒ}ₙ+3σₙ_{ₘₐₓ}=max. of all the measurements plus 3 std;
$$\overline{f} = \frac{1}{N} {\sum }_{n = 1}^{N} {f}_{n} = mean of nodes ;$$
ƒₐ=min((1−A)·ƒ̅, [symbol] )=lowest acceptable measurement;
ƒ_{d}=max((1+A)·ƒ, \vec{ƒ})=highest acceptable measurement;
A=an assumed agility factor (0<A<1).

17. The computer readable medium of claim 15 wherein updating said feature source comprises node creating and updating comprising:
determining if any node exists such that ƒ> [symbol] ₙ and ƒ<\vec{ƒ}ₙ; then
updating that node with ƒ; else
finding a node with minimal innovation, such that n*=argmin ƒ̅ₙ−ƒ; if
a normalized innovation d_{n*}=|ƒ̅_{n*}−ƒ|/\sqrt{σ_{ƒ}²+σ_{n*ƒ}²} is less than a threshold; then
updating said existing node; else,
creating a new node.

18. The computer readable medium of claim 15 wherein overfitting is prevented by node merging comprising:
ordering nodes such that ƒ̅ₙ<ƒ̅ₙ₊₁;
determining if a maximum of node n is less than a minimum of node n+1, where ƒ̅ₙ≤\vec{ƒ}ₙ< [symbol] ₙ₊₁≤ƒ̅ₙ₊₁; if
ƒ−Nσ_{ƒ}<\vec{ƒ}ₙ₋₁; or
ƒ+Nσ_{ƒ}>\vec{ƒ}ₙ₊₁; then
merging nodes.

19. A method of signals tracking performing a scalar agile parameter estimation for continuous-valued univariate parameters to estimate and track a likelihood of a measurement where a parameter distribution domain of an emitter is unknown, comprising:
receiving a signal from an emitter source;
measuring a feature of said signal;
calculating a likelihood of said feature by a feature likelihood tracking model;
adding a new parameter source model by creating a node, based on said feature likelihood;
establishing a likelihood of a measurement using a measurement likelihood tracking model;
starting a new feature track, based on said measurement likelihood; and
assigning said feature to a track;
whereby said signal is determined to be from an identified emitter by association of each of said emitters with a track.

20. The method of claim 15, wherein said signal is an RF signal.
